(19) United States
(12) Patent Application Publication
(10) Pub. No.: US 2015/0221092 A1
(43) Pub. Date: Aug. 6, 2015

(54) IMAGE PROCESSING METHODS AND SYSTEMS FOR FIBER ORIENTATION

(71) Applicant: Northeastern University, Boston, MA (US)

(72) Inventors: Yair MEGA, Cambridge, MA (US); Charles A. DIMARZIO, Cambridge, MA (US); James MCLEAN, Boston, MA (US); Jeffrey W. RUBERTI, Lexington, MA (US); Mike ROBITAILLE, Boston, MA (US); Ramin ZAREIAN, Boston, MA (US)

(21) Appl. No.: 14/578,869

(22) Filed: Dec. 22, 2014

Related U.S. Application Data
(63) Continuation of application No. PCT/US13/47400, filed on Jun. 24, 2013.
(60) Provisional application No. 61/663,259, filed on Jun. 22, 2012.

(51) Int. Cl. G06T 7/00; G06T 5/00

(52) U.S. Cl. CPC G06T 7/0044; G06T 7/001; G06T 7/0014; G06T 7/0046; G06T 5/009; G06T 2207/10056; G06T 2207/20056; G06T 2207/20024; G06T 2207/20208; G06T 2207/30004; G06T 2207/30108

(57) ABSTRACT

Disclosed herein are methods and systems for evaluating and modeling fibrous structures from one or more images. The methods and systems allow for robust, independent, and accurate quantification of fiber orientation in complicated structures, such as the undulating, interweaving, and multidirectional fibers of the human cornea. In addition, the methods and systems can be used to study, repair, and perform quality control on existing biological and industrial structures that include fibers (e.g., carbon nanotubes). Some embodiments can be used to predict the properties (e.g., strength, contrast, and material degradation) of and engineer new biological and industrial structures with fibers (e.g., synthetic corneas).

### RELATED APPLICATIONS

This application is a continuation of International Application Number PCT/US2013/047400, filed Jun. 24, 2013, which claims the benefit of U. S. Patent Application No. 61/663,259, filed Jun. 22, 2012, the entire contents of which are hereby incorporated by reference.

### TECHNICAL FIELD

The present disclosure relates generally to image processing methods and systems. More specifically, the present disclosure relates to methods and systems for evaluating fibrous structures in an image.

### BACKGROUND

Fibers (e.g., continuous filaments or discrete elongated pieces of material) are important to biology and industry. Natural fibers are produced by plants, animals, and geological processes. For example, natural fibers include vegetable and plant fibers, which are generally based on arrangements of cellulose (e.g., cotton, hemp, and flax); wood fibers (e.g., groundwood, thermomechanical pulp, and kraft or sulfite pulp); animal fibers, which consist largely of particular proteins (e.g., silkworm silk, catgut, and hair); mineral fibers (e.g., asbestos, wollastonite, and palygorskite). Synthetic fibers are often made from synthetic materials (e.g., polymer fibers like polyethylene and carbon fibers like carbon nanotubes), but some types of synthetic fibers are manufactured from natural raw materials (e.g., cellulose-based fibers like rayon). Industrial fibers may also be made from metals (e.g., stainless steel fibers) and glass (e.g., fiberglass and optical fibers).

Fibers are often used in the manufacture of other materials. The strongest engineering materials are generally made as fibers, for example, carbon fiber and ultra-high-molecular-weight polyethylene. Fibers can be spun into filaments, matted into sheets to make products like paper, or used as components of composite materials. For example, fiber-reinforced concrete contains short discrete fibers that are sourced, distributed, and oriented to lend varying properties to the concrete such as increasing its structural integrity.

Likewise, fibers naturally occurring in living organisms contribute to the properties and behaviors of biological structures. For example, muscle tissue includes myocytes (i.e., muscle fibers), which are long, tubular cells that may contain organized, regularly repeated arrangements of the myofibrillar contractile proteins actin and myosin. Another example is the long, fibrous protein collagen. Collagen fibers provide tensile strength and support to most tissues and are the main component of fascia, cartilage, ligaments, tendons, bone, and skin.

In highly-ordered collagen lamellae (i.e., layers of collagen fibers), the orientation of the fibers contributes significantly to the biomechanics of the tissue. For instance, collagen lamellae in the human cornea are superimposed on one another. The fibers themselves are crimped and run at different angles between the limbi. Fibers frequently interweave between the lamellae, the anterior lamellae fibers interweaving more than posterior lamellae fibers.

Depending on the material(s) and context, fiber orientation can have an effect on a wide range of properties such as, for example, strength (e.g., compressive, shear, and tensile), contrast, elasticity, conductivity, resistance, moisture absorption, and material degradation. As a result, analyses of fiber orientation would be useful for understanding, repairing, and performing quality control on existing structures that include fibers, as well as predicting the properties of and engineering new structures that include fibers.

Advances in imaging technology make it possible to acquire and visualize fibers in many biological and industrial structures. For example, second harmonic generation (SHG) is an optical modality widely used in biomedical optics to image collagen-based tissues. The coherent signal of the forward direction SHG produces a high resolution image that can resolve, for example, individual fibers (groups of fibrils) in the corneal stroma.

Current approaches to determining fiber orientation present many issues. Traditional image processing tools, such as the Radon transform or the Hough transform, are neither effective nor efficient for quantifying the orientation of multiple fibers having a crimped or undulating structure and running in one or more directions in an image. Both the Radon transform and the Hough transform are more suitable for finding straight lines in an image.

In another technique, forward direction SHG photons may be emitted when the orientation of some fibers is along the same direction as the polarization vector of the fundamental; however, the technique is complicated, may have limited value due to angular resolution constraints, and is only applicable to materials like collagen that have a second-order susceptibility.

A direct imaging aspect is also absent from X-ray scattering techniques. Data from x-ray scattering represents an integration of the entire z-stack (i.e., a set of images of planes at various depths within the sample) at a given measurement point and therefore lacks the depth resolution that can be achieved with multiphoton methods. In addition, the data will also be affected by crimps and undulations in fibers, as photons will be scattered differently from a crimped fiber structure.

Other techniques employ manual methods combined with a supporting analytical method, such as pixel interpolation and pathfinding, to validate results obtained during the process. However, manual methods lack consistency and are likely to give different results if performed by different users. Also, manual analysis of SHG images often biases the results. Furthermore, when dealing with a large dataset, such as is often collected from a z-stack or an orientation mapping across a large area, manual selection of the orientation is both tedious and very time consuming.

Fiber orientation in complicated structures, such as the undulating, interweaving, and multidirectional fibers of the cornea, remains challenging to determine using robust, independent, and accurate computational analysis of such images. Thus, a need exists for image processing methods for the quantitative evaluation of the orientation of one or more crimped or undulating fibers in an image.

### BRIEF SUMMARY

The present application discloses methods and systems for evaluating and/or modeling fibrous structures from one or more images. Some embodiments provide for robust, independent, and/or accurate quantification of fiber orientation in complicated structures, such as the undulating, interweaving, and multidirectional fibers of the human cornea. Embodiments can be used to study, repair, and/or perform quality control on existing biological and industrial structures that include fibers (e.g., carbon nanotubes). Embodiments also can be used to predict the properties (e.g., strength, contrast, and material degradation) of and/or help engineer new biological and industrial structures with fibers (e.g., synthetic corneas).

In one embodiment, a computer-implemented method for evaluating fiber orientation includes applying a fast Fourier transform to convert an image of a fibrous structure to a discrete Fourier transform (DFT) image in a spatial frequency domain, applying a filter to the DFT image to remove any interfering frequencies and obtain a filtered DFT image, applying a Radon transform (RT) to convert the filtered DFT image to an RT image as a function of a first variable and a second variable, the second variable comprising discrete angle values, selecting an RT component from the RT image where the first variable has a constant value and one or more peaks are present, and generating a representation of the RT component to evaluate one or more fiber orientations in the image of the fibrous structure.

In an embodiment, the fibrous structure includes a collagen-based tissue and/or a carbon nanotube. In an embodiment, the method further includes obtaining the image from microscopy, diffraction imaging, diffusion imaging, magnetic resonance imaging, angiography, ultrasound, and/or optical coherence tomography. In an embodiment, the image is a second harmonic generation microscopy image. In an embodiment, the method further includes enhancing contrast in the DFT image and/or the filtered DFT image. In an embodiment, the method further includes rotating the DFT image and/or the filtered DFT image by about 90 degrees. In an embodiment, the method further includes comparing the RT component to a peak threshold and identifying one or more angle values at which the RT component exceeds the peak threshold.

In one embodiment, a system for evaluating fiber orientation includes a processor configured to apply a fast Fourier transform to convert an image of a fibrous structure to a discrete Fourier transform (DFT) image in a spatial frequency domain, apply a filter to the DFT image to remove any interfering frequencies and obtain a filtered DFT image, apply a Radon transform (RT) to convert the filtered DFT image to an RT image as a function of a first variable and a second variable, the second variable comprising discrete angle values, select an RT component from the RT image where the first variable has a constant value and one or more peaks are present, and generate a representation of the RT component to evaluate one or more fiber orientations in the image of the fibrous structure, and storage for storing data and executable instructions to be used by the processor.

In an embodiment, the fibrous structure includes a collagen-based tissue and/or a carbon nanotube. In an embodiment, the system further includes an imaging subsystem that uses microscopy, diffraction imaging, diffusion imaging, magnetic resonance imaging, angiography, ultrasound, and/or optical coherence tomography. In a further embodiment, the imaging subsystem obtains a second harmonic generation microscopy image.

In an embodiment, the processor is further configured to enhance contrast in the DFT image and/or the filtered DFT image. In an embodiment, the processor is further configured to rotate the DFT image and/or the filtered DFT image by about 90 degrees. In an embodiment, the processor is further configured to compare the RT component to a peak threshold and identify one or more angle values at which the RT component exceeds the peak threshold.

In one embodiment, a non-transitory media for storing instructions that, when executed, include, responsive to an image of a fibrous structure, applying a fast Fourier transform to convert the image to a discrete Fourier transform (DFT) image in a spatial frequency domain, applying a filter to the DFT image to remove any interfering frequencies and obtain a filtered DFT image, applying a Radon transform (RT) to convert the filtered DFT image to an RT image as a function of a first variable and a second variable, the second variable comprising discrete angle values, selecting an RT component from the RT image where the first variable has a constant value and one or more peaks are present, and generating a representation of the RT component to evaluate one or more fiber orientations in the image of the fibrous structure.

In another embodiment, a computer-implemented method for creating a direction mosaic of a fibrous structure includes obtaining one or more images from an optical section of the fibrous structure, assembling the one or more images to create a mosaic representation of the optical section, applying a fast Fourier transform to convert each image to a discrete Fourier transform (DFT) image in a spatial frequency domain, applying a filter to each DFT image to remove any interfering frequencies and obtain a filtered DFT image, applying a Radon transform (RT) to convert each filtered DFT image to an RT image as a function of a first variable and a second variable, the second variable comprising discrete angle values, selecting an RT component from each RT image where the first variable has a constant value and one or more peaks are present, generating one or more representations of each RT component, and replacing the one or more images in the mosaic representation with the one or more representations of each RT component to create a direction mosaic of the optical section of the fibrous structure.

In one embodiment, the method further includes adjusting size and/or color of the one or more representations of each RT component. In one embodiment, the adjusting the size and/or color of the one or more representations of each RT component includes applying maximum value normalization. In one embodiment, the adjusting the size and/or color of the one or more representations of each RT component includes applying maximum integral/area normalization. In one embodiment, the method further includes comparing the direction mosaic of the optical section of the fibrous structure to a second direction mosaic from a different optical section of the fibrous structure.

As will be apparent to one of ordinary skill in the art from a reading of this disclosure, the disclosed subject matter can be embodied in forms other than those specifically disclosed herein. The particular embodiments described herein are, therefore, to be considered as illustrative and not restrictive. Those skilled in the art will recognize, or be able to ascertain, using no more than routine experimentation, numerous equivalents to the specific embodiments described herein.

### BRIEF DESCRIPTION OF THE FIGURES

The following figures are presented for the purpose of illustration only, and are not intended to be limiting:

FIG. 1 is a process flow diagram for evaluating fiber orientation in an image in accordance with some embodiments;

FIG. 2 is a schematic of a system for evaluating fiber orientation in an image in accordance with some embodiments;

FIGS. 3A-3D show the results of method steps for quantifying fiber orientation in a synthetically-generated image of fibers having a 60° tilt in accordance with some embodiments;

FIGS. 4A-4B show the results of method steps for quantifying fiber orientation in a synthetically-generated image of fibers having a 45° tilt and low amplitude crimps in accordance with some embodiments;

FIGS. 5A-5B show the results of method steps for quantifying fiber orientation in a synthetically-generated image of fibers having a 45° tilt and high amplitude crimps in accordance with some embodiments;

FIGS. 6A-6B show the results of method steps for quantifying fiber orientation in a synthetically-generated image of fibers having a 90° tilt and low amplitude crimps in accordance with some embodiments;

FIGS. 7A-7B show the results of method steps for quantifying fiber orientation in a synthetically-generated image of fibers having a 90° tilt and high amplitude crimps in accordance with some embodiments;

FIGS. 8A-8G show the results of method steps for quantifying fiber orientation in a synthetically-generated image of fibers in multiple directions and crimps of varying amplitude in accordance with some embodiments;

FIG. 9 is a schematic of the fibrous organization of a human cornea in accordance with some embodiments;

FIGS. 10A-10D are SHG microscopy images of human corneal collagen in accordance with some embodiments;

FIGS. 11A-11F show the results of method steps for quantifying fiber orientation in an SHG microscopy image with fibers having a dominant direction in accordance with some embodiments;

FIGS. 12A-12D show the results of method steps for quantifying fiber orientation in an SHG microscopy image with fibers in multiple directions in accordance with some embodiments;

FIG. 13 is a mosaic representation of a human cornea in accordance with some embodiments;

FIG. 14 is a direction mosaic of a human cornea in accordance with some embodiments;

FIGS. 15-16 are schematics for performing data processing on a direction mosaic of a human cornea in accordance with some embodiments;

FIGS. 17A-18D are processed direction mosaics of a human cornea in accordance with some embodiments;

FIGS. 19A-19D show the results of method steps for examining correlation between the direction and spatial location in accordance with some embodiments; and

FIGS. 20A-20D are direction-filtered direction mosaics of a human cornea in accordance with some embodiments.

### DETAILED DESCRIPTION

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The present disclosure involves new image processing methods and systems. More specifically, the present disclosure introduces methods and systems for evaluating fibrous structures in an image. The disclosed embodiments overcome existing challenges in evaluating fibrous structures by increasing the signal-to-noise ratio (SNR), robustness, independence, consistency, and/or accuracy of the identification and quantification of fiber orientation in an image of a fibrous structure. In some embodiments, methods and/or systems are used to quantify the orientation of one or more fibers with a crimped or undulating structure in an image. In further embodiments, methods and/or systems are used to quantify the orientation of multiple fibers with one or more orientations in an image. In some embodiments, methods and/or systems can be used to quantify the orientation of multiple fibers having a crimped or undulating structure and running in one or more directions in an image.

Some embodiments can be used to study, repair, and perform quality control on existing biological and industrial structures that include fibers (e.g., human corneal tissue and carbon nanotubes). Some embodiments can be used to predict the properties (e.g., strength, contrast, and material degradation) of and engineer new structures that include fibers (e.g., synthetic corneas and novel or hybrid carbon nanotubes).

In accordance with some embodiments, an image of a fibrous structure can be two-dimensional or three-dimensional. In some embodiments, an image can be rendered manually (e.g., by drawing), automatically (e.g., by computer generation), or by a combination of methods. In other embodiments, an image can be captured by an optical device, such as a camera, mirror, lens, telescope, and microscope. In further embodiments, an image can be obtained using imaging modalities, including but not limited to other forms of microscopy (e.g., SHG, electron, fluorescence, and confocal laser scanning), diffraction imaging (e.g., X-ray and electron), magnetic resonance imaging (e.g., diffusion), diffusion imaging (e.g., tensor and optical), angiography (e.g., fluorescein), ultrasound, and optical coherence tomography. In some embodiments, an image can be fixed, volatile, and/or moving.

In some embodiments, an image of a fibrous structure can be a digital representation in uncompressed, compressed, or vector formats. In further embodiments, image data for representing a fibrous structure can be organized and stored with a graphic file type/format, such as a raster format (e.g., a JPEG/JFIF, PNG, or GIF), vector format (e.g., CGM, Gerber, or SVG), or other format (e.g., a metafile or proprietary type). An image of a fibrous structure that is not a digital image can still be used with some embodiments. According to some embodiments, a non-digital image can be converted to a digital image (i.e., digitized). That is, a non-digital image can be sampled, and the samples can be quantized to obtain digital image data that can transmitted and processed using some embodiments. For example, an image can be digitized using image scanners including, but not limited to, photomultiplier tube (PMT) drum scanners, flatbed charge-coupled device (CCD) or contact image sensor (CIS) scanners, film scanners, hand scanners, three-dimensional scanners, planetary scanners, digital camera scanners, and combinations thereof.

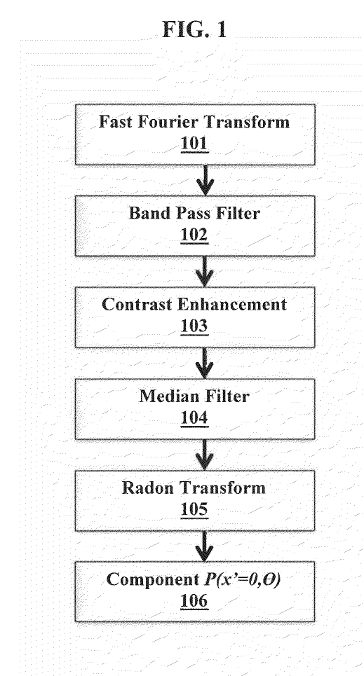

FIG. 1 is a process flow diagram for evaluating fiber orientation in an image according to some embodiments. In step 101, a fast Fourier transform (FFT) algorithm is applied to an image to compute the discrete Fourier transform (DFT) in two dimensions, thus converting the image to a representation in spatial frequency, referred to here as a DFT image. The DFT image represents the frequency with which the brightness modulate across space (e.g., both the x-axis and the y-axis of an original two-dimensional image). The magnitude of the DFT corresponds to its contrast, or the difference between the darkest and brightest peaks of the image. Although the DFT image contains all of the fiber orientation information, noise and/or interference in the DFT image can present an obstacle to quantifying the fiber orientation. Therefore, in step 102, a band pass filter (BPF) is applied to the DFT image. In some applications of some embodiments, a BPF with a minimum threshold of approximately 0.035 μm¹ and a maximum threshold of approximately 0.573 μm¹ is applied (as described in an example below); however, other values may be needed depending on the embodiment and application. The use of the BPF serves a dual purpose of removing at least (1) any background noise (e.g., a DC component that represents the average brightness across the whole image), and (2) any high frequencies caused by crimps or undulations in the fibers in the image. In some embodiments, when low frequency noise or interference is less concerning, the BPF may be replaced with a low pass filter (LPF). Likewise, in some embodiments, when high frequency noise or interference is less concerning, the BPF may be replaced with a high pass filter (HPF).

In optional step 103 of FIG. 1, the contrast of the remaining DFT image is enhanced. In some embodiments, contrast enhancement can be achieved by adjusting the histogram. A histogram is a function that counts the number of observations that fall into intervals or bins and can be represented as a graph of tabulated frequencies, shown as adjacent rectangles, each with an area equal to the frequency of the observations in the interval and a height equal to the frequency density of the interval (i.e., the frequency divided by the width of the interval). The adjustment of the histogram can help to eliminate the low value integrals in the DFT that do not contain real spatial information about the sample, yet produce a non-zero value result due to the noise in the image. In optional step 103, the histogram can be adjusted, for example, by doubling the minimum value while maintaining the maximum value of the histogram. The actual adjustment can vary between embodiments, depending on the level of background noise and the SNR of the image.

In optional step 104 of FIG. 1, a median filter (i.e., a non-linear process) is applied to the enhanced DFT image. The median filter can remove “salt and pepper” noise and can have a size of, for example, 4×4 pixels according to some embodiments. As referenced herein, “salt and pepper” noise is random noise that is unique to each pixel, but with some probability. It can refer to noise that produces an erroneous high value (thus appearing white in the image, i.e., like salt) or an erroneous low value (thus appearing black in the image, i.e., like pepper). Location does not affect “salt and pepper” noise (e.g., two adjacent pixels may share an erroneous value, but only as a coincidence). As a result, no specific frequencies are associated with “salt and pepper” noise. Thus, in some embodiments, a median filter is used to remove “salt and pepper” noise from the enhanced DFT image instead of a BPF, LPF, or HPF. The filtered DFT image is then rotated by 90 degrees to correct for the π/2 angular shift between information in the real and the Fourier domain. In some embodiments, the order of these processing steps may vary and additional processing steps may be applied to the DFT image.

In step 105 of FIG. 1, a Radon transform (RT) algorithm is applied to the processed DFT image to compute the RT in two dimensions, thus converting the image from frequency space to a representation in parameter space, referred to here as an RT image. The coordinates of a point in the RT image correspond to the parameters of a shape (e.g., the intensity at one or more lines having different angles) in the DFT image.

In some embodiments, the RT is less useful without the BPF of step 102. The DC component can affect the result of the RT. Because the DC component is the average brightness of the image, it is usually of a very high magnitude (e.g., several orders of magnitude higher than some of the higher frequencies) in the DFT image. As a result, integrals passing through the center of the DFT image (i.e., x′=0 in the RT image), would have a much higher RT result. Therefore, the application of the BPF in step 102 can improve the quantification of fiber orientation.

In the RT image, a peak corresponds to a distinguishable line in the FFT image. A line passing through the center of the DFT image contains only information from an orthogonal line in the real domain, regardless of the frequencies residing along that line, but a peak in the RT image indicates a dominant direction in the original image. In theory, an RT could be applied to an original image. However, in that case, any peaks of the RT image will be more scattered along the x′ axis. Even if they do not pass through the center of the original image, all lines oriented in a particular direction in the original image reside along a line that does pass through the center in the DFT image. Then, taking the RT ensures that any and all peaks are close to the center of the x′ axis in the RT image.

In step 106, a component function P(x′=0,θ) of the RT image is computed as a function of constant x′=0 and θ degrees. This P(x′=0,θ) component of the RT may be extracted and plotted to visualize RT peaks. The width of each RT peak represents the variation in angular information present within fibers in the orientation. The variation may be caused by natural deviation of the fibers and not necessarily crimped or undulating fibers.

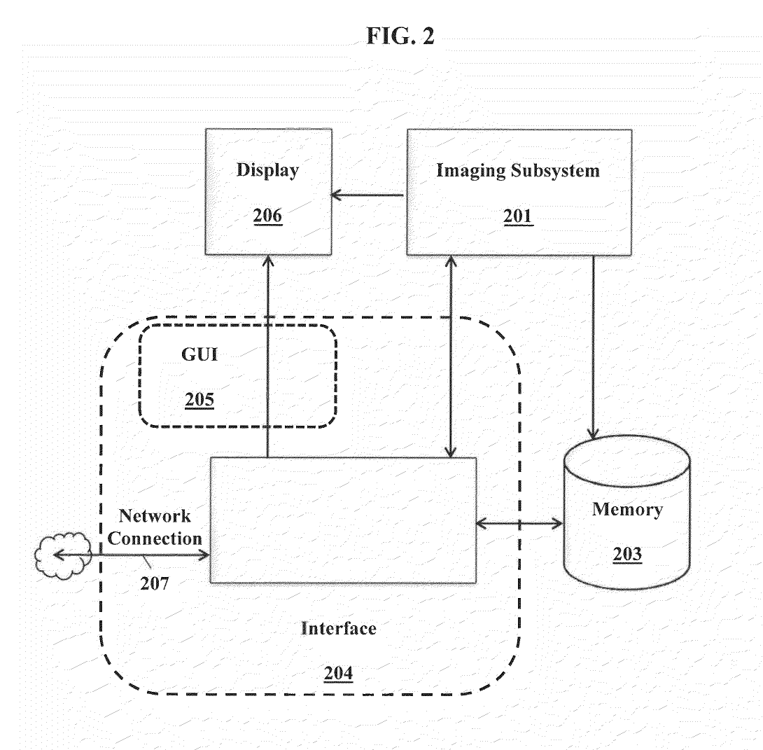

Referring to FIG. 2, in a typical operating environment, a system for quantifying fiber orientation in an image can include, but is not limited to, imaging subsystem 201, processor 202, memory 203, interface 204, graphical user interface (GUI) 205, display 206, and network connection 207 (each described in detail below). In practice, embodiments may be implemented in various forms of hardware, software, firmware, or a combination thereof. In some embodiments, modules are implemented in software as application programs that are then executed by user equipment. The user equipment may include desktop computers, laptop computers, netbooks, smartphones, and other forms of audio/visual equipment that can communicate with a network, an imaging unit, and/or an image storage unit.

According to some embodiments, the system includes one or more imaging and/or storage devices, shown collectively as imaging subsystem 201 in FIG. 2, that render, generate, capture, or otherwise acquire and/or store one or more images of a fibrous structure. In some embodiments, imaging subsystem 201 can include a non-transitory computer readable medium, flash memory, a magnetic disk drive, an optical drive, a programmable read-only memory, and/or a read-only memory. In some embodiments, imaging subsystem 201 can include any means by which an image (e.g., two-dimensional or three-dimensional and fixed, volatile, or moving) of a fibrous structure is rendered, generated, captured, or otherwise acquired, allowing for evaluation of fiber orientation. Suitable imaging modalities include, but are not limited to, other forms of microscopy (e.g., SHG, electron, fluorescence, and confocal laser scanning), diffraction imaging (e.g., X-ray and electron), magnetic resonance imaging (e.g., diffusion), diffusion imaging (e.g., tensor and optical), angiography (e.g., fluorescein), ultrasound, and optical coherence tomography. Some imaging modalities may require the use of one or more contrast agents. In some embodiments, imaging subsystem 201 may include a separate display and/or share display 206 with other components of the system shown in FIG. 2. Imaging subsystem 201 and its components may be operated manually, automatically, or by a combination thereof

According to some embodiments, the system includes one or more processors, shown collectively as processor 202 in FIG. 2, that execute instructions and run software that may be stored in memory 203. In some embodiments, the software needed for implementing a process or a database includes a high level procedural or an object-orientated language such as C, C++, C#, Java, Perl, or MATLAB®. The software may also be implemented in assembly language if desired. Processor 202 can be any applicable processing unit that combines a CPU, an application processing unit, and memory. Applicable processors can include any microprocessor (single or multiple core), system on chip (SoC), microcontroller, digital signal processor (DSP), graphics processing unit (GPU), combined hardware and software logic, or any other integrated circuit capable of processing instructions. Suitable operating systems can include MAC OS, Linux, Unix, MS-DOS, Windows, or any other operating system capable of executing the processes described herein.

Some embodiments may include one or more suitable memory devices, shown collectively as memory 203 in FIG. 2, such as a non-transitory computer readable medium, flash memory, a magnetic disk drive, an optical drive, a programmable read-only memory, and/or a read-only memory. Memory 203 stores the instructions for the above applications, which are executed by processor 202. Memory 203 also may store data relating to images, including original images of fibrous structures, DFT images, RT images, and plots of component function P(x′=0,θ) from RT images.

According to some embodiments, the system includes one or more interfaces, shown collectively as interface 204 in FIG. 2, that allow the processor 202 to interact with software, hardware, or peripheral elements, including but not limited to imaging subsystem 201, memory 203, GUI 205, display 206, and communication network 207 (using, e.g., a modem, wireless transceiver, or wired network connection). For example, as an input and/or output mechanism, interface 204 can operate to receive images from as well as transmit instructions to imaging subsystem 201. In some embodiments, interface 204 provides input and/or output mechanisms to communicate with a user. Suitable input/output devices to use with interface 204 may include, but are not limited to, a screen, a touch screen, a monitor, a printer, a modem, a transceiver, a keyboard, a microphone, a speaker, a pen device, a trackball, a touch pad, a mouse, a modem, and a transceiver.

Some embodiments may include GUI 205 to allow users to interact with the system using graphical icons and visual indicators. For example, a user may use input/output devices to communicate with the system and visually manipulate images and image processing data over GUI 205. Interface 204 and GUI 205 can operate under a number of different protocols. Interface 204 and GUI 205 also can be implemented in software or hardware to send and receive signals in a variety of mediums, such as optical, copper, and wireless, and in a number of different protocols some of which may be non-transient.

According to some embodiments, the system includes one or more display devices, shown collectively as display 206 in FIG. 2, that provide images and image processing data to a user. Display devices may include, but are not limited to, a screen, a touch screen, a monitor, a printer, a tactile display, and a speaker.

### EXAMPLES

Those skilled in the art will recognize, or be able to ascertain, using no more than routine experimentation, numerous equivalents to the specific substances and procedures described herein. Such equivalents are intended to be encompassed in the scope of the claims that follow the examples below.

Some embodiments were tested on synthetically-generated images, for which the fiber angles, amplitude of crimps or undulations, fiber thickness, and noise (e.g., a DC component) in the image are input parameters. The image processing steps were implemented using MATLAB® R2011a (available from The Mathworks, Inc., Natick, Mass.), but can be implemented using various forms of custom or packaged hardware, software, firmware, or a combination thereof. The results showed excellent matching to the predefined orientation of the crimped or undulating lines in the images. An evaluation of the orientation of one or more crimped or undulating fibers, especially when the crimps or undulations are high amplitude displacements from the overall fiber orientation, is challenging because the orientation of the crimps or undulations may be measured as a distinct direction. However, the direction of the crimps or undulations is not as valuable as determining the overall orientation of a fiber.

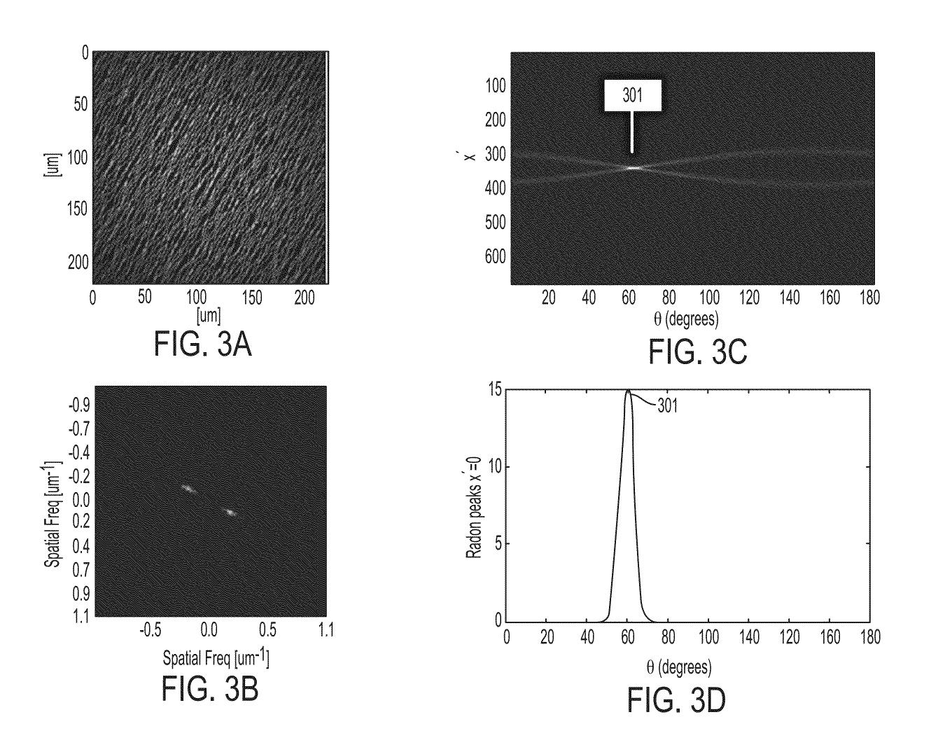

FIGS. 3A-3D show the results of method steps for quantifying fiber orientation according to some embodiments. FIG. 3A is a synthetically-generated image of fibers on the order of micrometers and generally oriented 60° from the x-axis. To quantify the fiber orientation in FIG. 3A, an FFT was applied to FIG. 3A to compute the DFT in two dimensions, thus converting FIG. 3A to a two-dimensional spatial frequency domain similar to FIG. 3B. Next, a BPF was applied to remove noise and interference from the DFT image, the contrast of the remaining DFT image was enhanced, a median filter was applied to the enhanced DFT image, and the filtered DFT image was then rotated by 90 degrees to correct for the π/2 angular shift between information in the real and the Fourier domain. These processing steps resulted in the DFT image shown in FIG. 3B. Then, an RT was applied to FIG. 3B to compute the RT in two dimensions, thus converting FIG. 3B to FIG. 3C. In FIG. 3C, an RT peak 301 corresponds to a distinguishable line in FIG. 3B and indicates a dominant direction in FIG. 3A. A component function P(x′=0, θ) of FIG. 3C was extracted and plotted in FIG. 3D in order to better visualize the RT peak 301 at P(x′=0,θ=60°). Thus, θ at RT peak 301 from which the fiber orientation was determined using an embodiment of the present disclosure matched the predefined fiber angle from which FIG. 3A was generated.

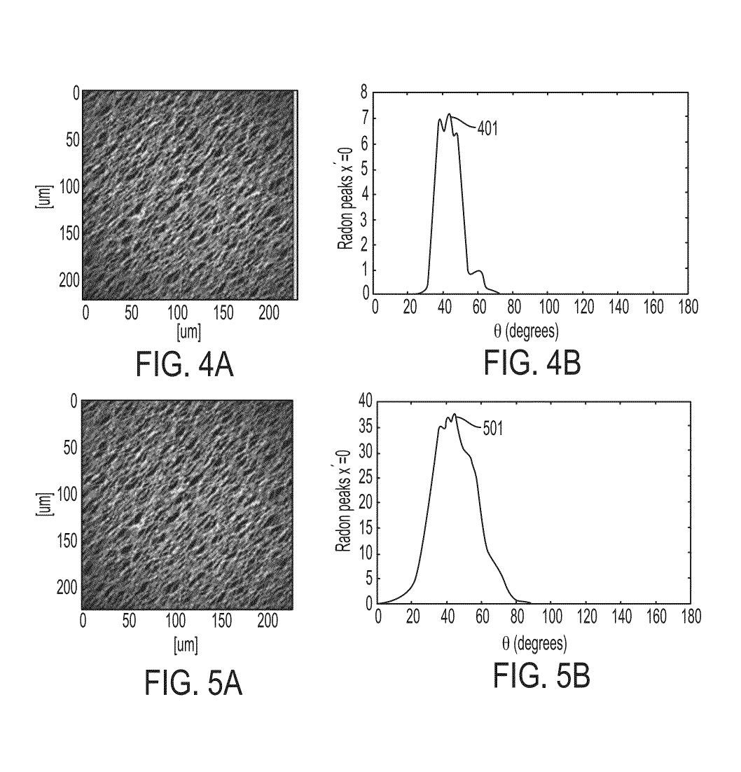

FIGS. 4A-4B show the results of method steps for quantifying fiber orientation for fibers having crimps with relatively low amplitude according to some embodiments. FIG. 4A is a synthetically-generated image of fibers on the order of micrometers, generally oriented 45° from the x-axis, and having low amplitude crimps. To quantify the fiber orientation, FIG. 4A was converted to spatial frequency (i.e., DFT), passed through a BPF to remove noise and interference, enhanced for better contrast, filtered by a median filter, and rotated by 90 degrees to correct for the π/2 angular shift between information in the real and the Fourier domain. Then, an RT was applied and component function P(x′=0, θ) of the RT was extracted and plotted in FIG. 4B in order to better visualize the RT peak 401 at P(x′=0, 0=45°. Thus, 0 at RT peak 401 from which the fiber orientation was determined using an embodiment of the present disclosure matched the predefined fiber angle from which FIG. 4A was generated.

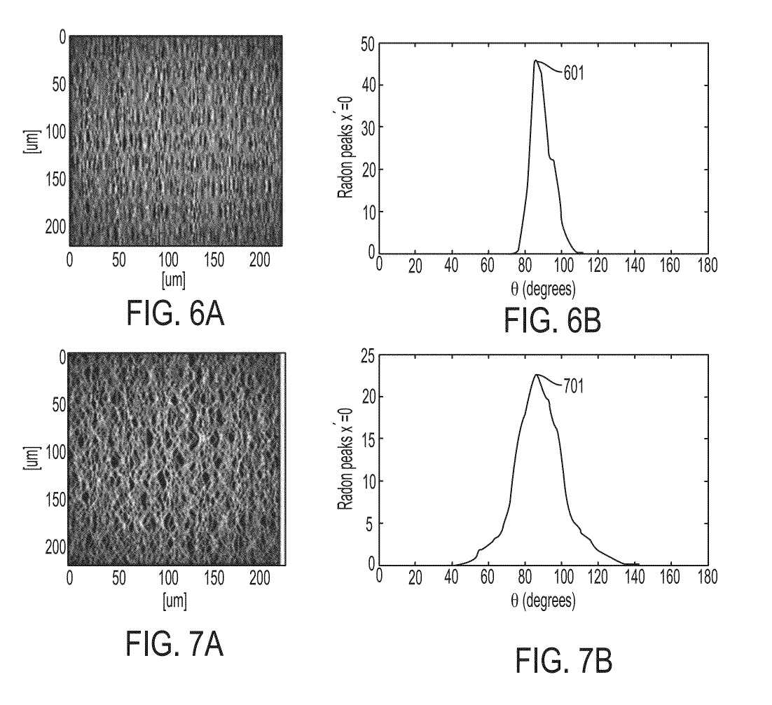

FIGS. 5A-5B show the results of method steps for quantifying fiber orientation for fibers having crimps with relatively high amplitude according to some embodiments. FIG. 5A is a synthetically-generated image of fibers on the order of micrometers, generally oriented 45° from the x-axis, and having high amplitude crimps. According to some embodiments to quantify the fiber orientation, FIG. 5A was processed so that the component function P(x′=0, θ) of the RT was extracted and plotted in FIG. 5B in order to better visualize the RT peak 501 at P (x′=0, θ=45°. As with θ at RT peak 401 in FIG. 4B, θ at RT peak 501 in FIG. 5B matched the predefined fiber angle from which FIG. 5A was generated. However, a comparison of FIGS. 4B and 5B shows that while θ at the RT peaks does not change, the shape, especially the width, of the RT peaks is different. Because the fibers in FIG. 5A have higher amplitude crimps than the fibers in FIG. 3A, the width of the RT peak 501 in FIG. 5B is greater, representing the variation in angular information present within fibers in the orientation.

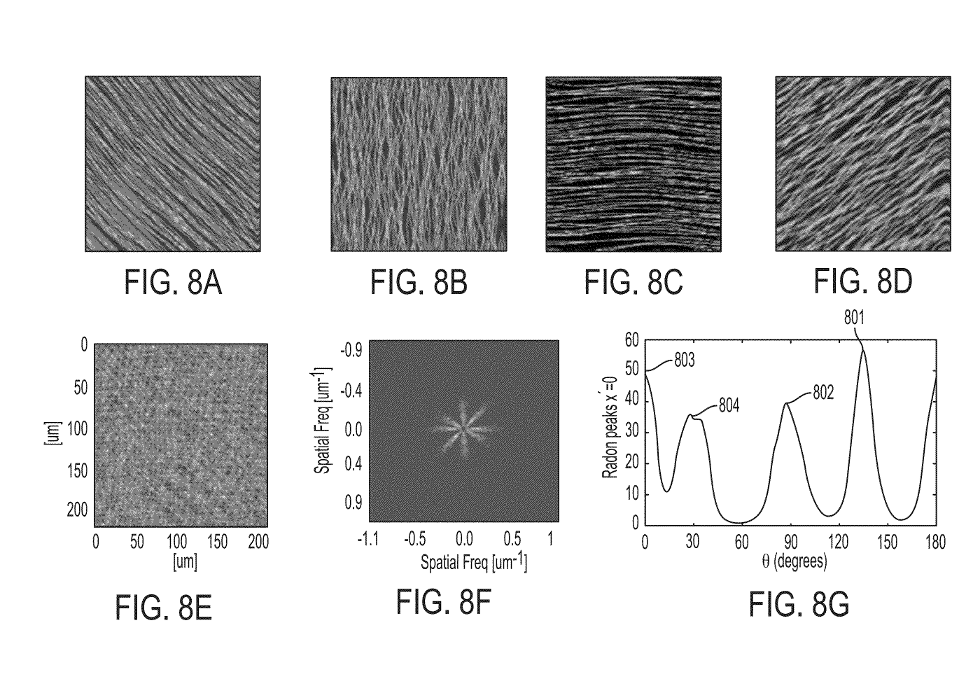

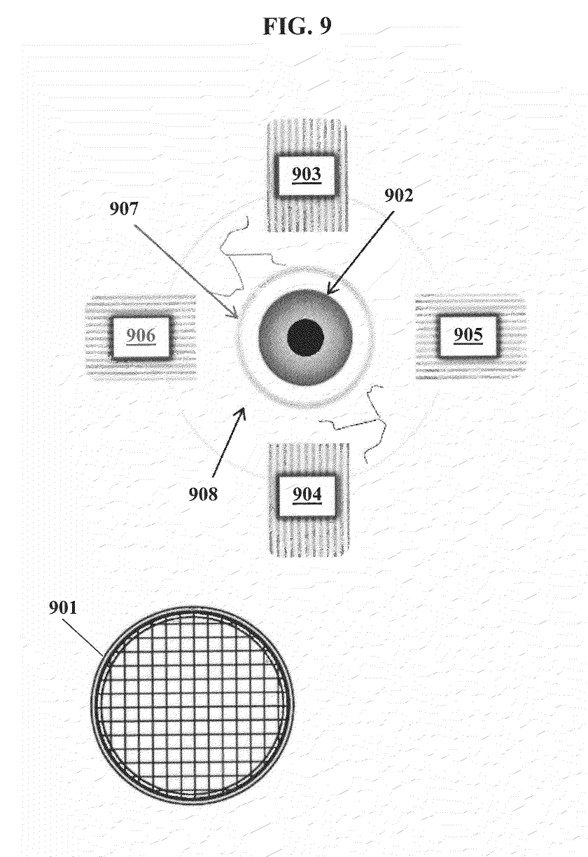

Likewise, FIGS. 6A-7B show the results of method steps for quantifying fiber orientation for fibers having crimps with varying amplitude according to some embodiments. FIG. 6A is a synthetically-generated image of fibers on the order of micrometers, generally oriented 90° from the x-axis, having low amplitude crimps, and resulting in a narrow RT peak 601 in FIG. 6B, compared to FIG. 7B in which a wider RT peak 701 signals the high amplitude crimps visible in FIG. 7A.

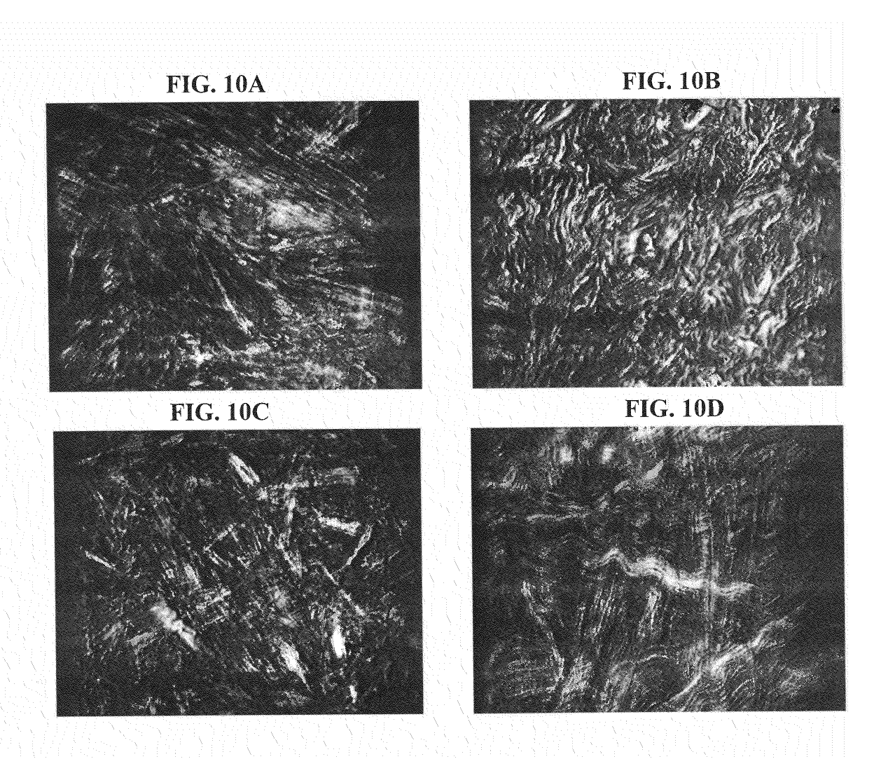

FIGS. 8A-8G show the results of method steps for quantifying fiber orientation for fibers running in multiple directions and having crimps with varying amplitude according to some embodiments. FIGS. 8A-8D are synthetically-generated images of fibers oriented in different directions (−45°, 90°, 0°, and 30° from the x-axis respectively) with crimps of varying amplitude. The fibers from FIGS. 8A-8D were superimposed to create a synthetically-generated image of fibers oriented in multiple directions, as shown in FIG. 8E. To quantify the different fiber orientations, FIG. 8E was converted to spatial frequency (FIG. 8F is the DFT image), passed through a BPF to remove noise and interference, enhanced for better contrast, filtered by a median filter, and rotated by 90 degrees to correct for the π/2 angular shift between information in the real and the Fourier domain. Then, an RT was applied and component function P(x′=0, θ) of the RT was extracted and plotted in FIG. 8G in order to better visualize the four RT peaks 801 at P(x′=0, θ=−45°), 802 at P(x′=0, θ=90°), 803 at P(x′=0, θ=0°), and 804 at P(x′=0, θ=30°). Thus, θ at RT peak 801, θ at RT peak 802, θ at RT peak 803, and θ at RT peak 804 from which the fiber orientations were determined using an embodiment of the present disclosure matched the predefined fiber angles from which FIG. 8E was generated.

Some embodiments can be used to evaluate the fibers in collagen lamellae (i.e., layers of collagen fibers) in the human cornea. The cornea is a vital component in the eye's mechanical structure and has a great effect on its optical functionality. The mechanical roles of the cornea include providing a front-line protection layer from injuries, maintaining the ocular pressure and withstanding the forces of the extraocular muscles during eye movement. Its optical role requires the cornea to be transparent to visible light and to have a precise curvature in order to support its functionality as the preliminary eye lens. The cornea's shape, being spherical near the visual axis and flattened at the periphery, is specifically designed to address the latter requirement. The shape of the cornea as well as its mechanical and optical properties, are derived from the specific arrangement of its collagen lamellae. The cornea is composed of mainly water and collagen types I, III and V, with type-I collagen being predominant. In addition to the mentioned fibril-forming collagen types, there are some non-fibril forming components including collagen type VI and XII.

The cornea is composed of several sections along the optical axis, yet the layer that is of most interest is the stroma. The stroma makes up approximately 90% of the entire corneal thickness and most of the fibrous collagen is found in this layer. The stroma has a layered structure where collagen lamellae, cross parallel to the surface of the cornea rather than through its thickness.

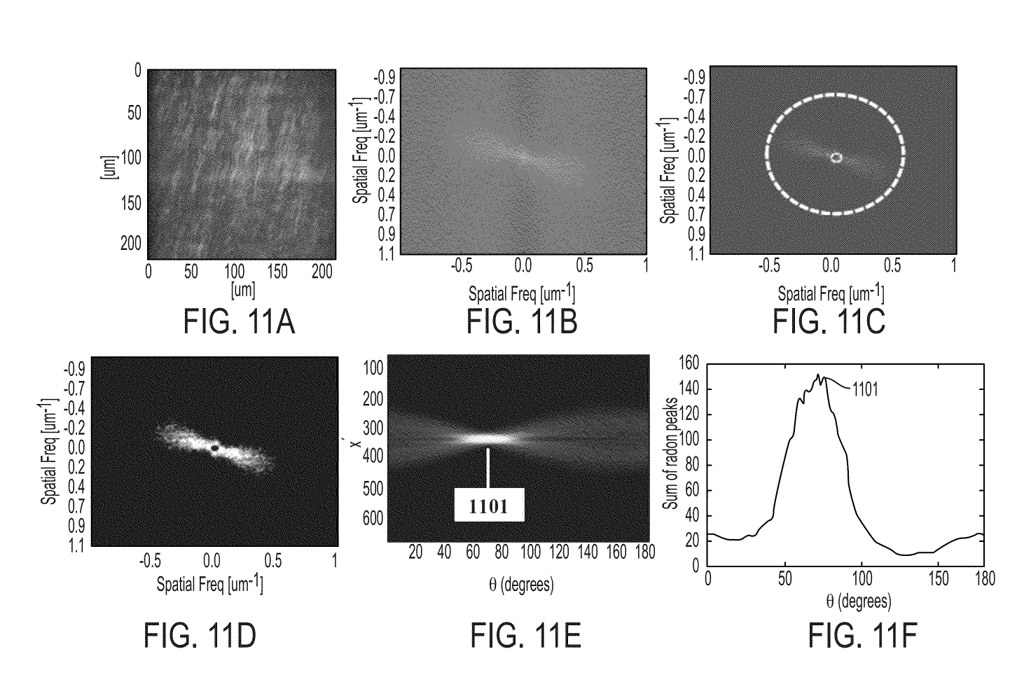

FIG. 9 is a schematic of the organization 901 of the collagen lamellae in the center of the cornea 902, which corresponds to the orientation of the superior-inferior and nasal-temporal directions. Correlations between the tensile strength of the collagen fibrils and their alignment with the direction of stress suggest that fibrils in the center of the human cornea adopt a preferred orientation necessary to resist the mechanical forces of the four rectus muscles: superior 903, inferior 904, nasal 905, and temporal 906. The limbal annulus region 907 is located at the interface between the cornea 902 and sclera 908, in order to provide additional reinforcement.

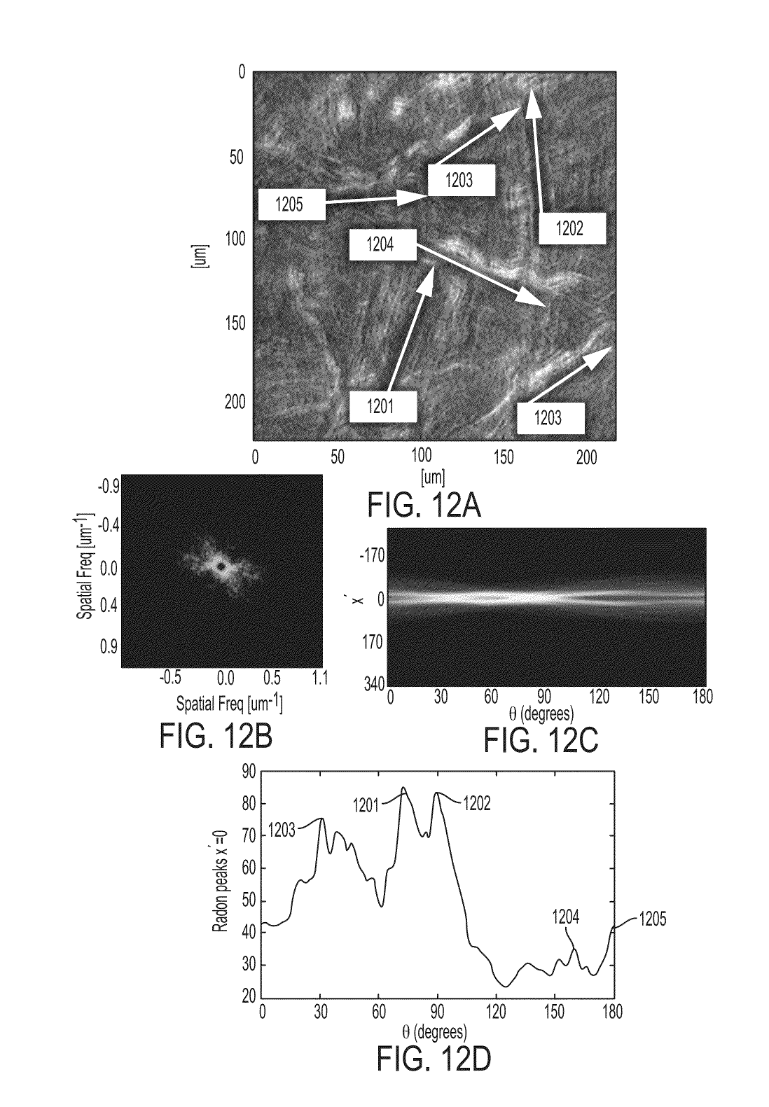

Advances in imaging technology make it possible to visualize fibers in many structures, including biological structures like the corneal stroma. For example, the effect of second harmonic generation (SHG) is used for high-resolution optical microscopy. Because of the non-zero second harmonic coefficient, only non-centrosymmetric structures (e.g., collagen-based tissues) are capable of emitting an SHG signal. The coherent signal of the forward direction SHG produces an image that can resolve individual fibers (groups of fibrils) in the corneal stroma with very high axial and lateral resolution. FIGS. 10A-10D are SHG microscopy images of human corneal collagen, which can be used in accordance with some embodiments to evaluate and/or quantify fiber orientation in the collagen. Each image has a field of view of 220×280 μm.

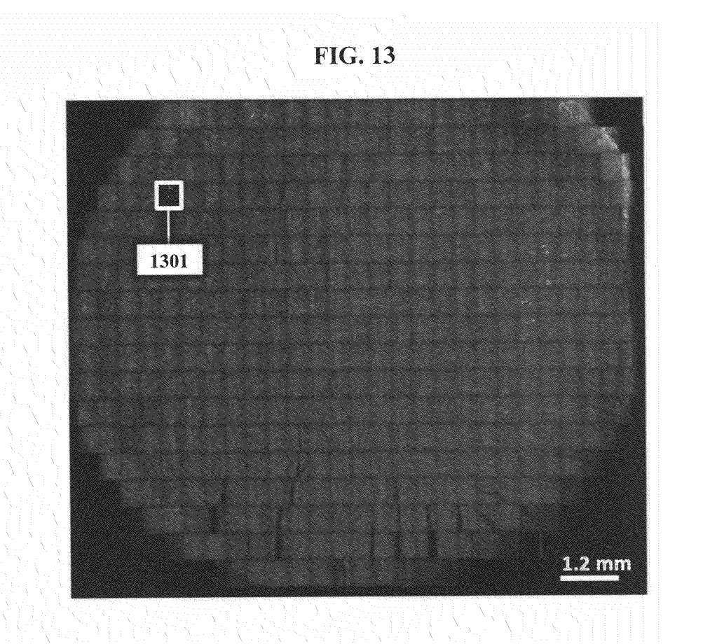

FIGS. 11A-11F show the results of method steps for quantifying fiber orientation in an SHG microscopy image with fibers having a dominant direction according to some embodiments. First, an image, as shown in FIG. 11A, was obtained. The original SHG microscopy image in FIG. 11A was taken from a bovine cornea obtained from a local abattoir. The sample was placed on a No. 1 microscope cover slip and imaged using an 800 nm excitation wavelength. The resulting image shows wavy fibers that are overall oriented at an angle close to yet smaller than 90° degrees (i.e., the nearly vertical lines in the image). The crimps in the fibers have a low amplitude with small changes in angle (i.e., only a few degrees).

To quantify the fiber orientation in FIG. 11A, an FFT was applied to the SHG image in FIG. 11A to compute the DFT in two dimensions, thus converting FIG. 11A to a two-dimensional spatial frequency domain as shown in FIG. 11B. Referring to the DFT image in FIG. 11B, energy in a wide distribution of spatial frequencies in the direction orthogonal to the lamellae is readily apparent. Although the DFT contains all of the orientation information, the noise in the FFT is an obstacle when formulating a conclusion regarding the orientation of the lamellae. The crimps in the fibers result in another peak on the DFT.

To overcome this challenge, a BPF with a minimum threshold of 0.035 μm⁻¹ and a maximum threshold of 0.573 μm⁻¹ (as illustrated in FIG. 11C) was applied to the DFT image to remove noise and the high frequency fibrous information from the lamellae. Next, the remaining DFT image was further filtered by adjusting the image contrast. A median filter with a size of 4×4 pixels was applied to the DFT image to remove “salt and pepper” noise. The image was then rotated by 90 degrees to correct for the π/2 angular shift between information in the real and the Fourier domain. FIG. 11D shows the DFT image thus processed.

The RT of the processed DFT image in FIG. 11D was taken to produce the RT image shown in FIG. 11E. The RT peak 1101 in FIG. 11E corresponds to a distinguishable line in FIG. 11D and indicates a dominant direction in FIG. 11A.

FIG. 11F is a plot of the component function P(x′=0, θ) (i.e., the line x′=0 line) of the RT image shown in FIG. 11E. The width of the RT peak 1101 represents the variation in angular information present within a lamella at a single orientation. The variation is caused by natural deviation of the fibers as often happens with biological samples. The shape and width of the RT peak 1101 in the plot of FIG. 11F and the total angular distribution of the processed DFT image in FIG. 11D were in agreement with previously reported angular information.

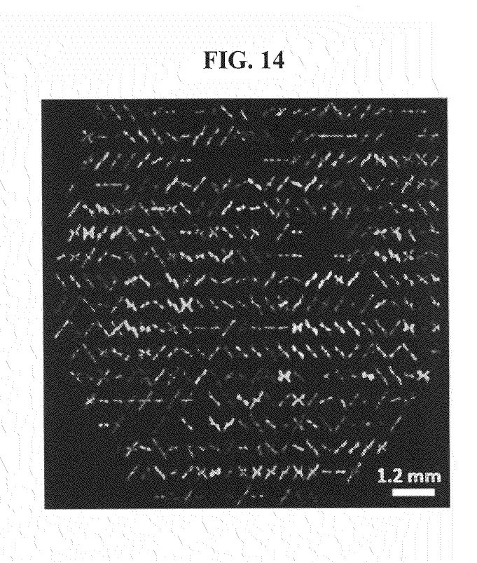

FIGS. 12A-12D show the results of method steps for quantifying fiber orientation in an SHG microscopy image with fibers running in multiple directions according to some embodiments. FIG. 12A is an SHG microscopy image showing lamellae with several different orientations. In this more complicated case where multiple directions are present, manual measurement of the directionality of the lamellae is more difficult and less accurate, in part, because an observer is more likely to disregard the intensity information and focus more on structural information, treating bright and dark areas of an image nearly the same. However, a brighter SHG signal implies a higher concentration of fibers present in the focal plane, whereas other structural information might be slightly out-of-focus. Also, when measuring the angular information manually, an observer is expecting a pattern of crossing lines. Therefore, the observer may fill in the missing information based on expectation when viewing an image containing crimpy lamellae or having noncontinuous fibers. Manual measurement combined with pixel interpolation or pathfinding algorithms will therefore bias results.

To quantify the fiber orientation, an FFT was applied to the SHG image in FIG. 12A to compute the DFT in two dimensions, thus converting FIG. 12A from real domain to a DFT function in the two-dimensional spatial frequency domain. As previously described, the DFT image was filtered and enhanced to obtain the processed DFT image shown in FIG. 12B. Then, an RT was applied to the processed DFT image in FIG. 12B to produce the RT image shown in FIG. 12C.

FIG. 12D is a plot of the component function P(x′=0, θ) (i.e., the line x′=0 line) of the RT image shown in FIG. 12C. As can be observed, FIG. 12D shows several RT peaks matching directions of fibers that are present in the SHG microscopy image in FIG. 12A. The peaks in FIG. 12D take into account the intensity information. Arrows 1201-05 in FIG. 12A highlight the high value directional integrals taken from the analysis shown in FIG. 12D. The maximum peak 1201 appears at approximately 70° in FIG. 12D and corresponds to the direction of the fibers in the area that resides underneath arrow 1201 in FIG. 12A. The next highest peak 1202 at approximately 90° in FIG. 12D corresponds to the direction under arrow 1202 in FIG. 12A. These areas have a noticeably high intensity in the SHG microscopy image in FIG. 12A, and as a result, the values of RT integrals from the areas are higher.

As demonstrated qualitatively in FIGS. 11A and 11G, what may appear as a single direction in an image may, in practicality, contain a span of angles. For example, in FIG. 12A there are several directions under arrows 1203 that are relatively close to an approximately 30° orientation. Each direction has a certain band of angles present in the sheet of fibers and those bands of angles overlap with nearby information and creating the broad peak 1203 in FIG. 12D.

A distinct orientation also appears under arrow 1204 in FIG. 12A that has a corresponding wide peak 1204 at approximately 160° in FIG. 12D. As can be seen in in FIG. 12A, a high level of crimps are present along that direction under arrow 1204. Those crimps, using existing methods, would have been miscounted as corresponding to approximately 0° and/or 60° orientations, but here are instead counted as a part of the 160° lamella.

A small peak 1205 of approximately 0° is present in FIG. 12D. The corresponding region under arrow 1205 has low intensity (i.e., it is darker than other lamellae) in the SHG microscopy image in FIG. 12A.

In some embodiments, more than one image of part of a fibrous structure may be obtained and used to produce a mosaic representation of the fibrous structure. In further embodiments, more than one image of part of a fibrous structure may be obtained and used to produce a mosaic representation of the directions of fibers in the structure (i.e., a direction mosaic). For example, SHG images were collected at several z-sections and used to produce a mosaic representation and a direction mosaic of the cornea in order to detail the lamellar configuration through various z-slices across the cornea. /

According to some embodiments, a custom-designed, multi-modal, point scanning microscope based on an inverted microscope (e.g., TE2000 with an objective having 20× magnification and a numerical aperture of 0.75 NA, both available from Nikon Instruments, Inc., Melville, N.Y.) was used with a fast polygonal-galvanometric scanning system and a second photo multiplier tube (PMT) (e.g., H9305-01, available from Hamamatsu Photonics K.K., Bridgewater, N.J.) to allow forward SHG signal detection.

According to some embodiments, two human cornea samples, approximately 11 mm in diameter, were prepared for imaging by being placed between coverslips, in order to hold the sample in the center and to keep the sample as flat as possible, to assure it is perpendicular to the imaging plane across the whole surface of the cornea. The prepared samples with the coverslips were then mounted to the stage of the inverted microscope to be imaged. The samples were excited using a 800 nm wavelength. A narrow BPF (e.g., FB400-10 400±2 nm, available from Thorlabs, Inc., Newton, N.J.) was placed in front of each of the backward and forward PMT modules. Four z-sections were taken from both samples. For a first sample, 22×22 SHG microscopy images were taken at each z-section with steps of 5 μm, to create a mosaic representation. For a second sample, 21×30 SHG microscopy images were taken for each z-section with steps of 2 μm along the z direction. The 22×22 sample was designed to have an equal sampling rate in the x and y directions, while the 21×30 sample was designed to have an equal sampling area (since each image has a field of view of 280×220 μm with 640×480 pixels).

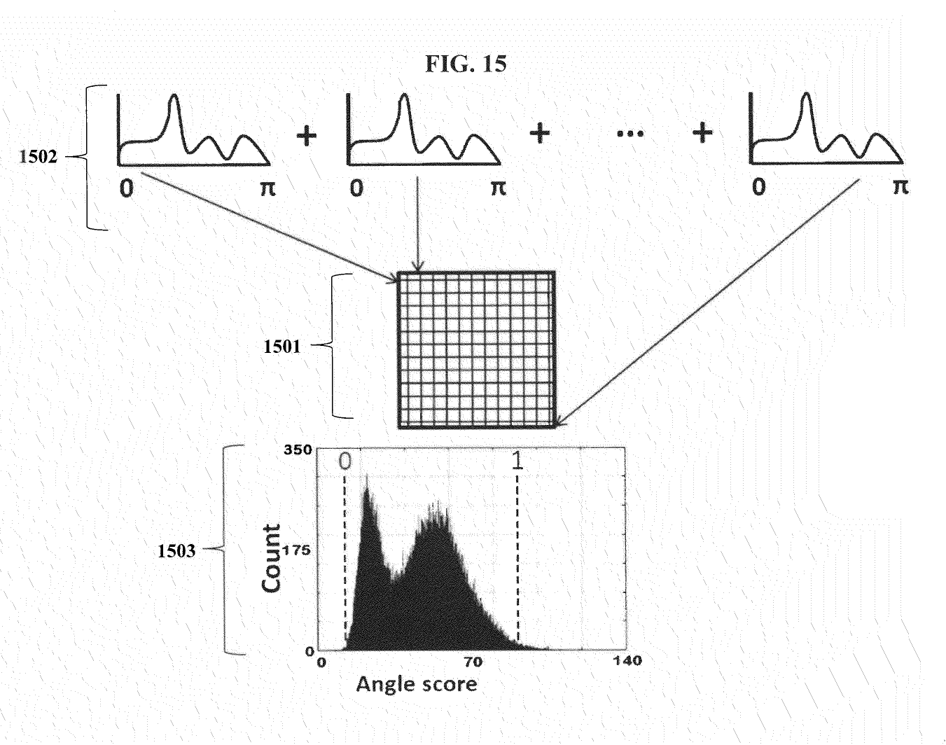

FIG. 13 is a mosaic representation made of individual images 1301, specifically of the 21×30 images of the second sample, stitched together to form a complete representation of the cornea according to some embodiments. A total of four z-sections was chosen as the maximum number of slices to be imaged since the imaging time for each slice is approximately 6 hours, after which the sample begins to dehydrate and shrink.

According to some embodiments, each image from a mosaic representation is processed using methods described above. For example, each of the 21×30 SHG microscopy images from the mosaic representation in FIG. 13 was processed to quantify the fiber orientation, using steps described above, resulting in 21×30 plots of the component function P(x′=0, θ) (i.e., the line x′=0 line) from the corresponding RT images, where a value in arbitrary units was obtained for each discrete angle value between 0° and 180° to represent the presence of fibers in that direction.

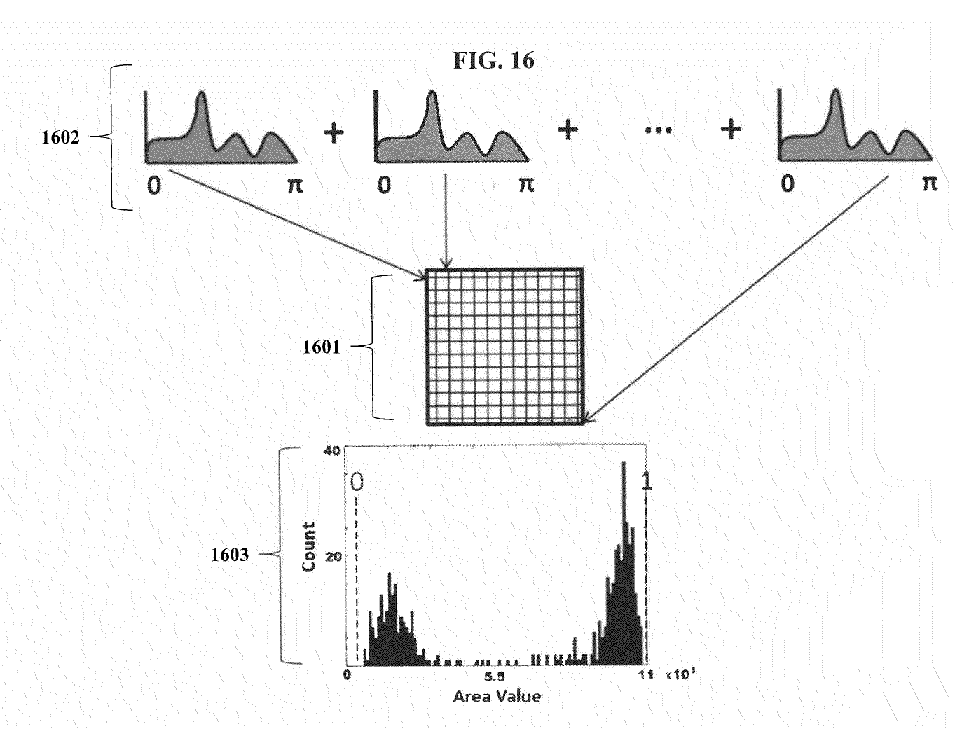

The fiber orientation data is then re-represented using a polar plot. A polar plot is obtained by duplicating the data points of the 0°-180° plot to also represent data points for the 181°-360° directions. The latter is justified since a result of either 45° or 135° represents a fiber pointing at the same direction. The individual images in a mosaic representation of a fibrous structure are replaced with the individual polar plots to create a mosaic representation composed of polar plots, referred to herein as a direction mosaic. For example, the polar plots were used to replace the individual SHG microscopy images in the mosaic representation of FIG. 13, resulting in the direction mosaic shown in FIG. 14.

According to some embodiments, the representation of the direction mosaics can be processed further in order to allow easier observation of, for example, the crossing lamellae. Improvement of the direction mosaics can include adjusting the size and/or the color of each polar plot. In some embodiments, the adjustment of size and color can be done using maximum value normalization and/or maximum area/integral normalization.

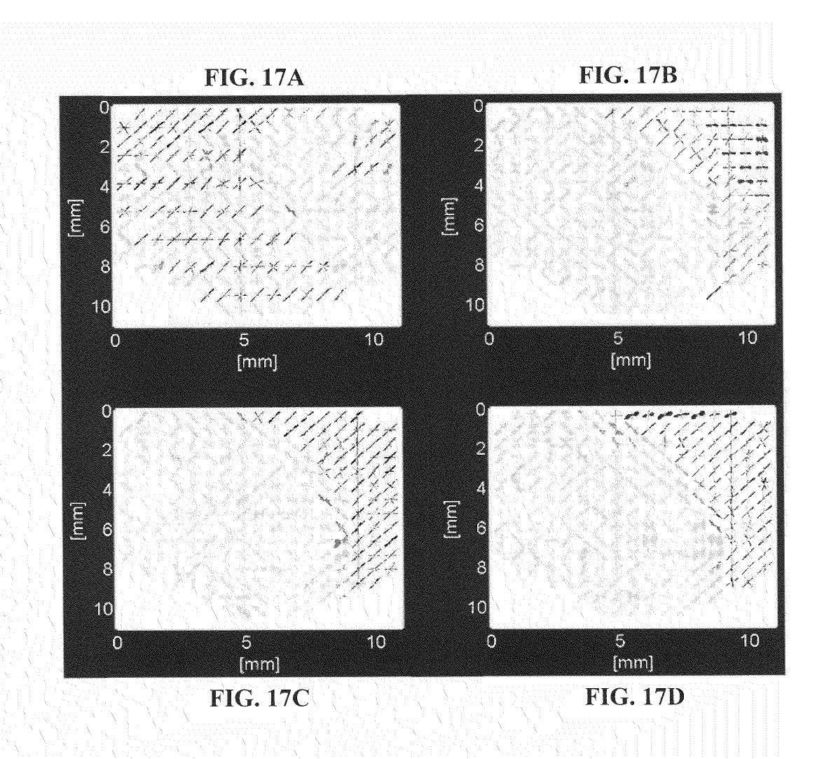

FIG. 15 is a schematic of maximum value normalization for processing a direction mosaic according to some embodiments. First, for each z-section 1501, all the data values from the RT component functions P(x′=0, θ) 1502 are aggregated from all the corresponding images across that z-section 1501. Next, the aggregated values are normalized between 0 and 1 such that higher values from the RT component functions P(x′=0, θ) 1502 are considered to have a stronger and more pronounced presence of fibers in that direction and are therefore weighted accordingly. In order to avoid scaling, while accounting for outliers, the distribution of the direction values 1503 is taken for each z-section 1501 and a percentile value is used to replace the maximum value for the scaling. FIG. 15 shows the distribution of the direction values 1503 for the direction mosaic shown in FIG. 14. A percentile value of 65 was used to replace the maximum value for the scaling, after it was found empirically to be the most adequate. The distribution of the direction values 1503 shows a bi-modal behavior with a long tail towards the higher values. This behavior was typical to all z-sections from both samples.

FIG. 16 is a schematic of maximum integral/area normalization for processing a direction mosaic according to some embodiments. First, for each image in each z-section 1601, the plot area of each RT component function P(x′=0, θ) 1602 is calculated. Next, the area values are normalized between 0 and 1. FIG. 16 shows the distribution of the integrals/areas values 1603 for the direction mosaic shown in FIG. 14. The distribution of the integrals/areas values 1603 shows a bi-modal behavior with a wide separation between the two modes' values. This behavior was also typical to all z-sections from both samples.

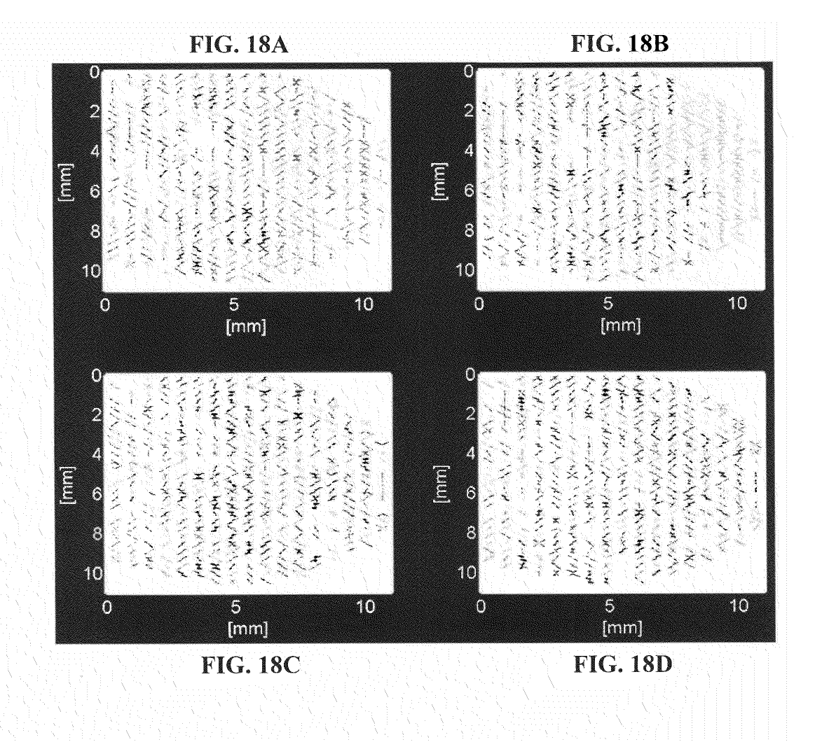

FIGS. 17A-17D are processed direction mosaics taken from four z-sections of a human cornea according to some embodiments. The direction mosaics were taken at 5-μm steps along the z-direction at locations 0 μm (FIG. 17A); 5 μm (FIG. 17B); 10 μm (FIG. 17C); 15 μm (FIG. 17D). The color of each polar plot in the direction mosaics was scaled using maximum value normalization.

The direction mosaics in FIGS. 17A-17D show support for the hypothesis of a woven-like lamellae structure in the cornea. In FIG. 17A, the alternating locations have alternating dominant direction. Given the sectioning resolution of SHG microscopy of approximately 5 μm, this suggests a woven organization of the lamellae, where the lamella from below the focal plane is brought into and out of the plane of focus. Moving to the subsequent figures, that is, deeper in the z-direction into the sample, the lamella at the top-right of FIGS. 17A-17D grows in area. The growing area, along with the area's uniform direction and color, suggests a different lamella is being brought into the focal plane. Uniformity in color indicates similar gray brightness of the original SHG image. Since the image brightness is related to the amount of collagen present in the focal plane, uniformity in the color can indicate a relationship to a certain lamella, since a lamella tends to keep its consistency along the cornea.

FIGS. 18A-18D are processed direction mosaics taken from four z-sections of a human cornea according to some embodiments. The direction mosaics were taken at 2-μm steps along the z-direction at locations 0 μm (FIG. 17A); 2 μm (FIG. 17B); 4 μm (FIG. 17C); 6 μm (FIG. 17D). Two colors are dominant in the direction mosaics. The presence of two dominant colors complies with the distribution of the maximum area/integral normalization. In order to examine if whether a relationship exists between two color regions of FIG. 4 and the direction of the lamellae present in that location, a direction filter was applied. A direction filter switches off any desired range of angles, by assigning a zero value to the angles in the data obtained. An examination of the direction distribution was performed in order to find the dominant directions numerically. The direction distribution showed two dominant directions—40° and 150°—of the lamellae. The filter was then applied correspondingly with a ±5° tolerance angle. In FIGS. 18A-18D, similar to FIGS. 17A-17D, there is good agreement to the high and low area distributions of the maximum area/integral normalization as depicted in FIG. 16.

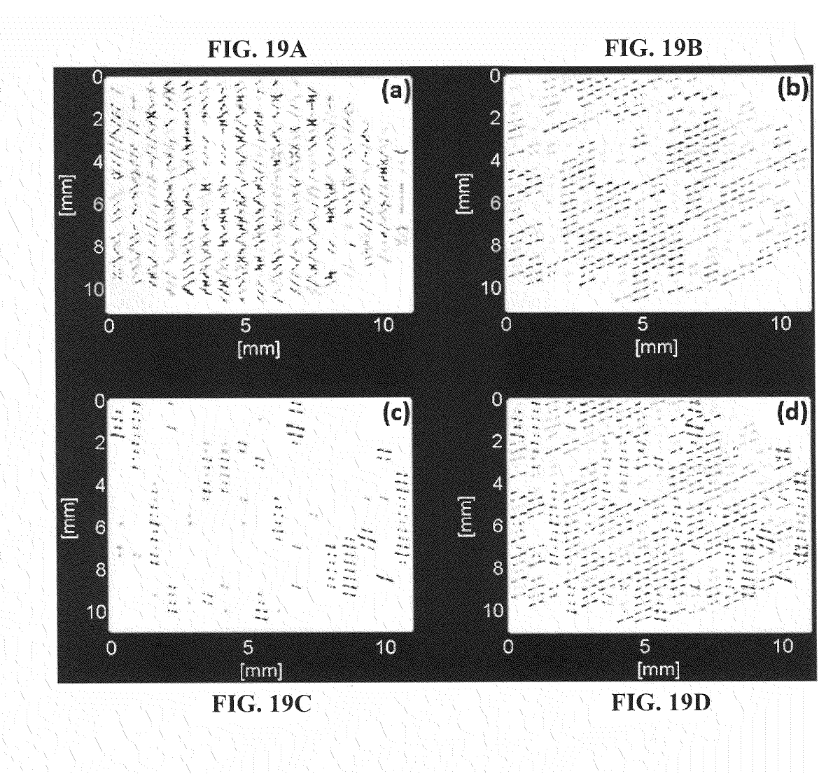

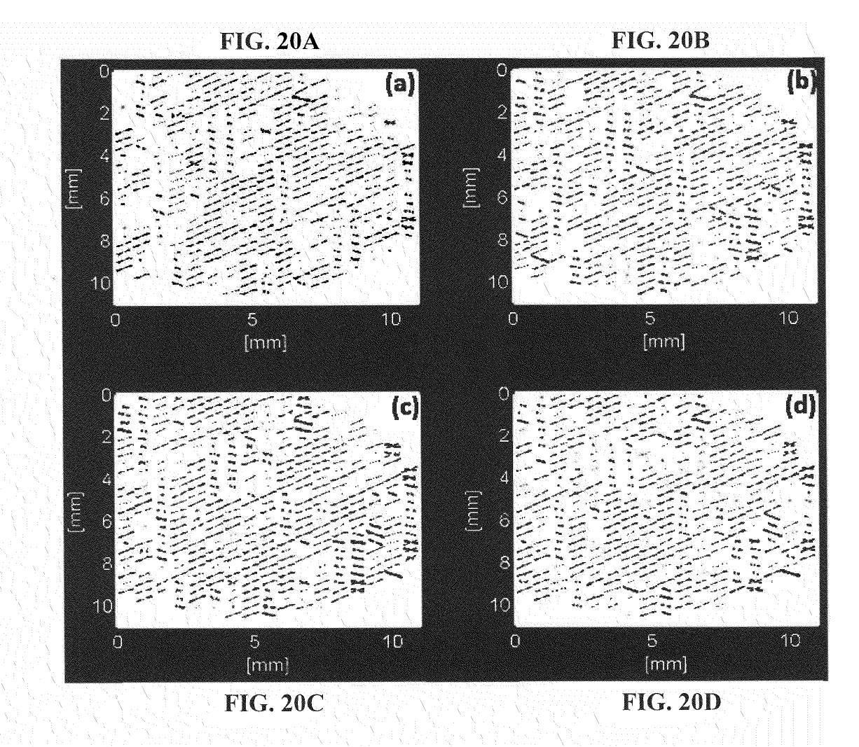

FIGS. 19A-19D show the results of method steps for examining the correlation between maximum integral normalization value and direction according to some embodiments. FIG. 19A is the unfiltered direction mosaic of FIG. 18C. FIGS. 19B and 19C are the filtered 150±5° and 40±5° direction mosaics of FIG. 19A, respectively. FIGS. 19B and 19C were superimposed to produce the overlapping direction mosaic shown in FIG. 19D. Qualitative observation of the latter suggests a correlation between the directions and spatial locations of the fibers. Regions containing very little to no presence of the 150±5° direction mosaic showed significant presence of the 40±5° direction mosaic and vice versa. This behavior suggests that different lamellae have different consistency and orientation with a woven organization going in and out of the place of focus. This behavior was typical to all the direction mosaics that were processed using the direction filter approach. For example, FIGS. 20A-20D are the filtered direction mosaics of the four z-sections of a human cornea in FIGS. 18A-18D processed using the 150±5° and 40±5° direction filters according to some embodiments. Behavior similar to FIG. 19D can be observed in all four filtered directions mosaics.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A computer-implemented method for evaluating fiber orientation, comprising:
applying a fast Fourier transform to convert an image of a fibrous structure to a discrete Fourier transform (DFT) image in a spatial frequency domain;
applying a filter to the DFT image to remove any interfering frequencies and obtain a filtered DFT image;
applying a Radon transform (RT) to convert the filtered DFT image to an RT image as a function of a first variable and a second variable, the second variable comprising discrete angle values;
selecting an RT component from the RT image where the first variable has a constant value and one or more peaks are present; and
generating a representation of the RT component to evaluate one or more fiber orientations in the image of the fibrous structure.

2. The method of claim 1, wherein the fibrous structure comprises at least one of a collagen-based tissue and a carbon nanotube.

3. The method of claim 1, wherein the representation is used for quality control of products comprising one or more fibers.

4. The method of claim 1, wherein the representation is used for diagnostics of biological tissue comprising one or more fibers.

5. The method of claim 1, further comprising obtaining the image from at least one of microscopy, diffraction imaging, diffusion imaging, magnetic resonance imaging, angiography, ultrasound, and optical coherence tomography.

6. The method of claim 1, wherein the image is a second harmonic generation microscopy image.

7. The method of claim 1, further comprising enhancing contrast in at least one of the DFT image and the filtered DFT image.

8. The method of claim 1, further comprising rotating at least one of the DFT image and the filtered DFT image by about 90 degrees.

9. The method of claim 1, further comprising:
comparing the RT component to a peak threshold; and
identifying one or more angle values at which the RT component exceeds the peak threshold.

10. A system for evaluating fiber orientation, comprising:
a processor configured to
apply a fast Fourier transform to convert an image of a fibrous structure to a discrete Fourier transform (DFT) image in a spatial frequency domain,
apply a filter to the DFT image to remove any interfering frequencies and obtain a filtered DFT image,
apply a Radon transform (RT) to convert the filtered DFT image to an RT image as a function of a first variable and a second variable, the second variable comprising discrete angle values,
select an RT component from the RT image where the first variable has a constant value and one or more peaks are present, and
generate a representation of the RT component to evaluate one or more fiber orientations in the image of the fibrous structure; and
storage for storing data and executable instructions to be used by the processor.

11. The system of claim 10, wherein the fibrous structure comprises at least one of a collagen-based tissue and a carbon nanotube.

12. The system of claim 10, wherein the representation is used for quality control of products comprising one or more fibers.

13. The system of claim 10, wherein the representation is used for diagnostics of biological tissue comprising one or more fibers.

14. The system of claim 10, further comprising an imaging subsystem that uses at least one of microscopy, diffraction imaging, diffusion imaging, magnetic resonance imaging, angiography, ultrasound, and optical coherence tomography.

15. The system of claim 14, wherein the imaging subsystem obtains a second harmonic generation microscopy image.

16. The system of claim 10, wherein the processor is further configured to enhance contrast in at least one of the DFT image and the filtered DFT image.

17. The system of claim 10, wherein the processor is further configured to rotate at least one of the DFT image and the filtered DFT image by about 90 degrees.

18. The system of claim 10, wherein the processor is further configured to compare the RT component to a peak threshold, and identify one or more angle values at which the RT component exceeds the peak threshold.

19. A non-transitory media for storing instructions that, when executed, include:
responsive to an image of a fibrous structure, applying a fast Fourier transform to convert the image to a discrete Fourier transform (DFT) image in a spatial frequency domain;
applying a filter to the DFT image to remove any interfering frequencies and obtain a filtered DFT image;
applying a Radon transform (RT) to convert the filtered DFT image to an RT image as a function of a first variable and a second variable, the second variable comprising discrete angle values;
selecting an RT component from the RT image where the first variable has a constant value and one or more peaks are present; and
generating a representation of the RT component to evaluate one or more fiber orientations in the image of the fibrous structure.

20. A computer-implemented method for creating a direction mosaic of a fibrous structure, comprising:
obtaining one or more images from an optical section of the fibrous structure;
assembling the one or more images to create a mosaic representation of the optical section;
applying a fast Fourier transform to convert each image to a discrete Fourier transform (DFT) image in a spatial frequency domain;
applying a filter to each DFT image to remove any interfering frequencies and obtain a filtered DFT image;
applying a Radon transform (RT) to convert each filtered DFT image to an RT image as a function of a first variable and a second variable, the second variable comprising discrete angle values;
selecting an RT component from each RT image where the first variable has a constant value and one or more peaks are present;
generating one or more representations of each RT component; and
replacing the one or more images in the mosaic representation with the one or more representations of each RT component to create a direction mosaic of the optical section of the fibrous structure.

21. The method of claim 20, further comprising adjusting at least one of size and color of the one or more representations of each RT component.

22. The method of claim 21, wherein the adjusting the at least one of size and color of the one or more representations of each RT component comprises applying maximum value normalization.

23. The method of claim 21, wherein the adjusting the at least one of size and color of the one or more representations of each RT component comprises applying maximum integral/area normalization.

24. The method of claim 20, further comprising comparing the direction mosaic of the optical section of the fibrous structure to a second direction mosaic from a different optical section of the fibrous structure.
